(19) United States
(12) Patent Application Publication
(10) Pub. No.: US 2025/0322166 A1
(43) Pub. Date: Oct. 16, 2025

(54) Key Phrase Generation Using Indefinite Sequence Learning

(71) Applicant: eBay Inc., San Jose, CA (US)

(72) Inventors: Soumik Dey, San Jose, CA (US); Hansi Wu, Cupertino, CA (US); Rui Zhang, University Park, PA (US); Haoran Zhang, State Collage, PA (US); Binbin Li, Cupertino, CA (US); Bensu Ucar, Amsterdam (NL); Julie Cheng, Los Gatos, CA (US)

(73) Assignee: eBay Inc., San Jose, CA (US)

(21) Appl. No.: 19/005,475

(22) Filed: Dec. 30, 2024

Related U.S. Application Data
(60) Provisional application No. 63/633,430, filed on Apr. 12, 2024.

(51) Int. Cl. G06F 40/289; G06F 40/284; G06N 20/00

(52) U.S. Cl. CPC G06F 40/289; G06F 40/284; G06N 20/00

(57) ABSTRACT

Key phrase generation using indefinite sequence learning is described. In accordance with the described techniques, a sequence generation model generates a sequence of key phrases based on an input document. During the generation task, the sequence generation model omits use of a self-generated sequence termination token. Key phrases in the sequence are then output as recommended key phrases for the input document.

### RELATED APPLICATIONS

This application claims priority to U.S. Application No. 63/633,430 titled Extreme Multi-label Classification, filed Apr. 12, 2024, which is hereby incorporated by reference in its entirety.

### BACKGROUND

Key phrase recommendation is a technique used in various domains, including e-commerce, search engines, and content creation. Generally, key phrase recommendation techniques identify and suggest words or phrases that enhance user experience, visibility, and engagement of content items. For example, recommended key phrases for a content item, when searched, are effective to surface the content item or similar content items within a search results page.

### SUMMARY

Key phrase generation using a sequence generation model is described. As part of this, a key phrase recommendation system receives an input document and generates a sequence of key phrases based on the input document using a sequence generation model. The sequence generation model is configured to omit use of a self-generated sequence termination token during generation of the sequence. Generally, a self-generated sequence termination token is a token generated by traditional sequence generation models that triggers and/or marks the termination of the sequence generation task. By omitting use of this token, the sequence generation model is able to perceive the key phrase generation task as indefinite. Instead, the described techniques rely on an external mechanism (e.g., a logits processor) to terminate the key phrase generation task after a predefined number of key phrases have been generated by the sequence generation model. Key phrases in the sequence are then output as recommended key phrases for the input document.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ techniques described herein.

FIG. 2 depicts a system showing operation of a key phrase recommendation system during a training phase.

FIG. 3 depicts a system showing operation of a key phrase recommendation system to generate an augmented training dataset.

FIG. 4 depicts a system showing operation of a key phrase recommendation system during a re-training phase.

FIG. 5 is an example showing user interfaces displayable in accordance with the described techniques.

FIG. 6 is an example of a serving architecture that is operable to employ techniques described herein.

FIG. 7 depicts a procedure in an example implementation of key phrase generation using indefinite sequence learning.

FIG. 8 depicts a procedure for training a sequence generation model in accordance with one or more implementations.

FIG. 9 depicts a procedure for re-training a sequence generation model on an augmented training dataset in accordance with one or more implementations.

FIG. 10 illustrates an example of a system that may implement the various techniques described herein.

### DETAILED DESCRIPTION

### Overview

Key phrase recommendation systems are often implemented to recommend key phrases for documents published online. These documents are exposed to users via a search platform, which enables the users to search for the documents, e.g., by submitting user queries. In an online marketplace, for example, listings are published online, and users can search for those listings via a search platform of the online marketplace. In this context, a key phrase recommendation system may be employed to generate recommended key phrases for item listings listed via the online marketplace. One solution for key phrase recommendation employs sequence generation models, which are machine learning models trained to generate key phrases in a sequential manner. Conventional sequence generation models, however, typically use a self-generated sequence termination token to terminate the sequential key phrase generation task.

These models are trained on datasets that exhibit popularity bias. That is, a document (e.g., an item listing) is paired with a key phrase in the training data if the document is engaged with (e.g., clicked) at least a threshold number of times in response to the key phrase being searched via the search platform. While unpopular documents may make up a majority of documents available for search, unpopular documents typically receive sufficient engagement to be paired with just one key phrase in the training data. Thus, a key phrase may not be paired with a document in the training data (despite being relevant to the document) because it is buried behind more popular items within the search results, and as such, does not receive sufficient engagement to be paired with the key phrase.

Conventional sequence generation models inherit this popularity bias of the training data on which they are trained. Since conventional sequence generation models are configured to self-generate the sequence termination token, for instance, they learn to generate the sequence termination token prematurely, e.g., after only one or a few generated key phrases. This is because the training data typically includes a limited number (e.g., one or two) key phrases before the sequence of key phrases is terminated. Thus, conventional models exhibit an early-termination problem based on these models' reliance on the self-generated sequence termination token, which is often triggered too soon based on the biased training data.

To address these limitations, key phrase generation using indefinite sequence learning is described. In accordance with the described techniques, a sequence generation model is trained to process an input document published online via a search platform, and generate a sequence of key phrases for the document. In contrast to conventional models, the sequence generation model is trained and/or configured to omit use of a self-generated sequence generation token, allowing the sequence generation model to perceive the key phrase generation task as indefinite. In some instances, the sequence generation model is a transformer-based natural language processing model.

For example, the sequence generation model receives an input document as input, and outputs a key phrase sequence. To do so, the sequence generation model operates in an autoregressive manner to generate tokens sequentially. For instance, when generating a next sequential token of the key phrase sequence, the sequence generation model uses previously generated tokens as context. In order to generate a key phrase of the sequence, the sequence generation model generates a start token (e.g., marking the beginning of the key phrase), one or more content tokens (e.g., representing the words within the key phrase), and an end token. The start and end tokens delineate the key phrase from other key phrases in the sequence.

In accordance with the described techniques, the sequence generation model omits use of a self-generated sequence termination token. Rather than the sequence generation model deciding when to terminate the key phrase generation task, for instance, an external mechanism (e.g., a logits processor) is configured to terminate the key phrase generation task. That is, the logits processor enforces a threshold key phrase count, causing the sequence generation model to stop generating key phrases when the threshold key phrase count is reached. The omission of the self-generated key phrase token enables the sequence generation model to generate sequence tokens indefinitely, instead relying on an external mechanism to trigger termination of the key phrase generation task.

By removing the self-generated sequence termination token, the described techniques overcome deficiencies and popularity bias in the training data. For example, the sequence generation model is able to leverage the biased training data (e.g., that is formulated based on engagement data) during training to learn to produce outputs that reflect key phrases that are likely to produce engagement given an input document. Moreover, the omission of the sequence generation token enables the sequence generation model to continue generating key phrases beyond the number of key phrases that are typically paired with a document in the training data. Furthermore, the sequence generation model uses its autoregressive functionality and natural language processing capabilities to generalize to unseen data, e.g., generating key phrases that were not exposed to the sequence generation model during training, but are still relevant to the input document. Thus, the described techniques improve key phrase recommendations by generating a more comprehensive and diverse set of relevant key phrases given an input document. This also allows the key phrase recommendation system to conserve computational resources such as memory, communication bandwidth, and processor usage. For instance, generating more relevant key phrases in a single pass may reduce the need for multiple processing iterations by the sequence generation model, decreasing overall computational load and resource utilization.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

### Example of an Environment

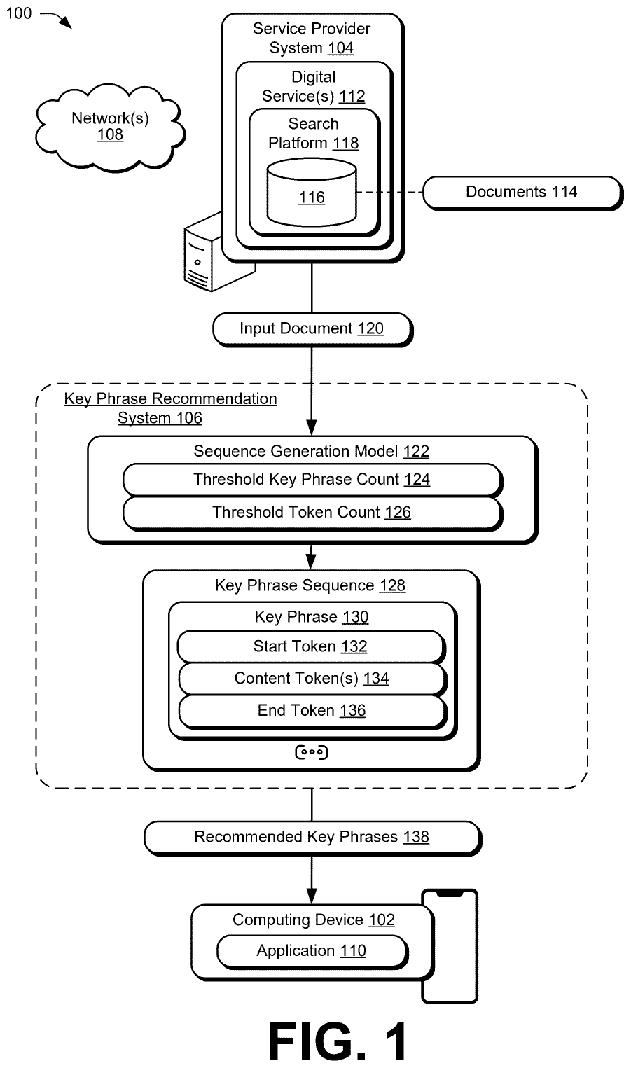

FIG. 1 is an illustration of an environment 100 in an example implementation that is operable to employ techniques described herein. The environment 100 includes a computing device 102, a service provider system 104, and a key phrase recommendation system 106. In one or more implementations, the computing device 102, the service provider system 104, and the key phrase recommendation system 106 are communicatively coupled, one to another, via network(s) 108. One example of the network(s) 108 is the Internet, although one or more of the computing device 102, the service provider system 104, and the key phrase recommendation system 106 may be communicatively coupled using one or more different connections or different networks in various implementations.

Although the key phrase recommendation system 106 is depicted in the environment 100 as being separate from the computing device 102 and the service provider system 104, in one or more implementations, an entirety or various portions of the key phrase recommendation system 106 are implemented at or by the computing device 102 and/or the service provider system 104. In at least one implementation, for example, at least a portion of the key phrase recommendation system 106 is implemented by an application 110 of the computing device 102 and/or using various resources of the computing device 102, such as hardware resources, an operating system, firmware, and so forth. Alternatively or additionally, at least a portion of the key phrase recommendation system 106 is implemented by resources (e.g., server-based storage, processing, and so on) of the service provider system 104. Alternatively or additionally, at least a portion of the key phrase recommendation system 106 is implemented using a third-party service, such as a web services platform that provides one or more hardware and/or other computing resources to support provision of services by web service providers.

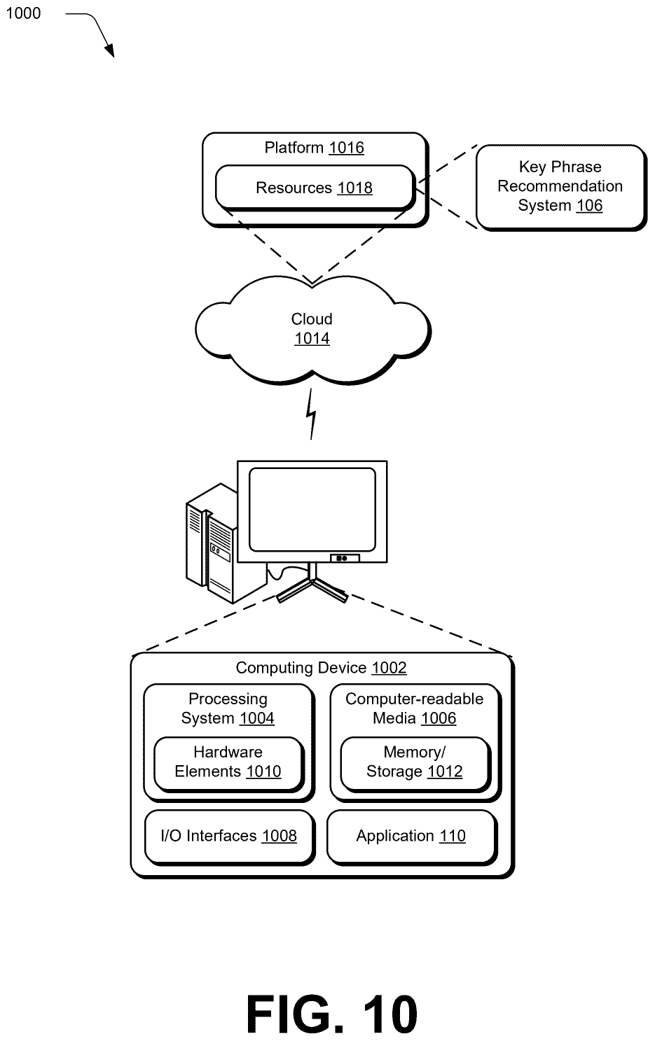

Computing devices that implement the environment 100 are configurable in a variety of ways. A computing device, for instance, is configurable as a desktop computer, a laptop computer, a mobile device (e.g., assuming a handheld configuration such as a tablet or mobile phone), an IoT device, a wearable device (e.g., a smart watch, a ring, or smart glasses), an AR/VR device (e.g., the smart glasses), a server, and so forth. Thus, a computing device ranges from full resource devices with substantial memory and processor resources to low-resource devices with limited memory and/or processing resources. Additionally, although in instances in the following discussion reference is made to a computing device in the singular, a computing device is also representative of a plurality of different devices, such as multiple servers of a server farm or data center utilized to perform operations “over the cloud” as further described in relation to FIG. 10.

In at least one implementation, the application 110 supports communication of data across the network(s) 108, such as between the computing device 102 and the service provider system 104 and/or between the computing device 102 and the key phrase recommendation system 106. By supporting such data communication, the application 110 provides a respective user of the computing device 102 (and users of other computing devices) access to digital services 112. For example, the computing device 102 receives data from the service provider system 104. Based on the received data, the application 110 causes various systems of the computing device 102 to output user interfaces of the digital services 112 such as by displaying user interfaces via display devices or making accessible voice-based user interfaces.

Digital services 112 can take a variety of forms in the context of key phrase generation and recommendation. In various implementations, the digital services 112 are configured for publishing content online, e.g., for consumption and/or viewing by users of the digital services 112. Examples of digital services 112 that may implement the described key phrase generation techniques include, but are not limited to, online marketplaces and/or e-commerce platforms, content management systems, search engine optimization tools, digital advertising platforms, news websites, blogs, social media platforms, and academic repositories.

Through interaction of a user with the computing device 102, the application 110 receives user input via one or more user interfaces of the digital services 112. Examples of such input include, but are not limited to, receiving touch input in relation to portions of a displayed user interface, receiving one or more voice commands, receiving typed input (e.g., via a physical or virtual (“soft”) keyboard), receiving mouse or stylus input, and so forth. One example of the application 110 is a browser, which is operable to navigate to a website of the digital services 112, display pages of the website, and facilitate user interaction with web pages of the website. Another example of the application 110 is a web-based computer application of the digital services 112, such as a mobile application or a desktop application. The application 110 may be configured in different ways, which enable users to interact with their computing devices and by extension perform actions with respect to the digital services 112, without departing from the spirit or scope of the techniques described herein.

One such action is to publish a document 114 online via the digital services 112. Documents 114 can take various forms depending on the nature of the digital service 112. For example, in an online marketplace context, the documents 114 can correspond to item listings including details such as item descriptions, item titles, item images, pricing, and seller information. In a content management system, the documents 114 can correspond to blog posts, articles, and/or web pages. In the case of academic repositories, the documents 114 can be research papers, theses, and the like.

A plurality of users may publish documents 114 online via the digital services 112. The service provider system 104 maintains these documents 114 in a storage device 116, which may be implemented as a database, file system, mass storage, virtual storage, or other data storage solution. In one or more implementations, for example, the storage device 116 may be virtualized across a plurality of data centers and/or cloud-based storage devices.

The digital services 112 employ a search platform 118 that makes the documents 114 available for search by users. Users can access and interact with these documents 114 through user interfaces provided by the digital services 112, e.g., via the application 110 on the computing device 102. In some implementations, the search platform 118 may receive user queries through these interfaces. Upon receiving a query, the search platform 118 may search the indexed data of documents 114 stored in the storage device 116, and surface documents 114 that match the user query as search results, which may be displayed to the user through the application 110.

For instance, in an online marketplace scenario, a user may publish a listing for an item they wish to sell. This listing becomes a document 114 stored in the storage device 116. The search platform 118 then indexes this listing, making it discoverable by other users who may search for related items. Similarly, in a content management system, an author might publish an article, which is stored as a document 114 and made searchable through the search platform 118's search functionality.

In accordance with the described techniques, the key phrase recommendation system 106 receives or obtains an input document 120, e.g., of the documents 114. In particular, the input document 120 is provided as input to a sequence generation model 122, which is a machine learning model trained to process the input document 120, and generate a sequence of key phrases associated with (e.g., relevant to) the content of the input document 120. In some implementations, the sequence generation model 122 is a transformer-based natural language processing (NLP) model. However, the sequence generation model 122 can have other architectures in various implementations. Examples of other architectures include recurrent neural networks (RNNs), long short-term memory (LSTM) networks, and convolutional neural networks (CNNs).

In some cases, the sequence generation model 122 is a smaller footprint model trained “from scratch,” e.g., starting with uninitialized or randomly initialized parameters. However, in some scenarios, the sequence generation model 122 is a fine-tuned variant of a large language model. Examples of large language models that can be fine-tuned for this purpose include bi-directional encoder representations from transformers (BERT) models, generative pre-trained transformer (GPT) models, text-to-text-transfer (T5) models, and their variants.

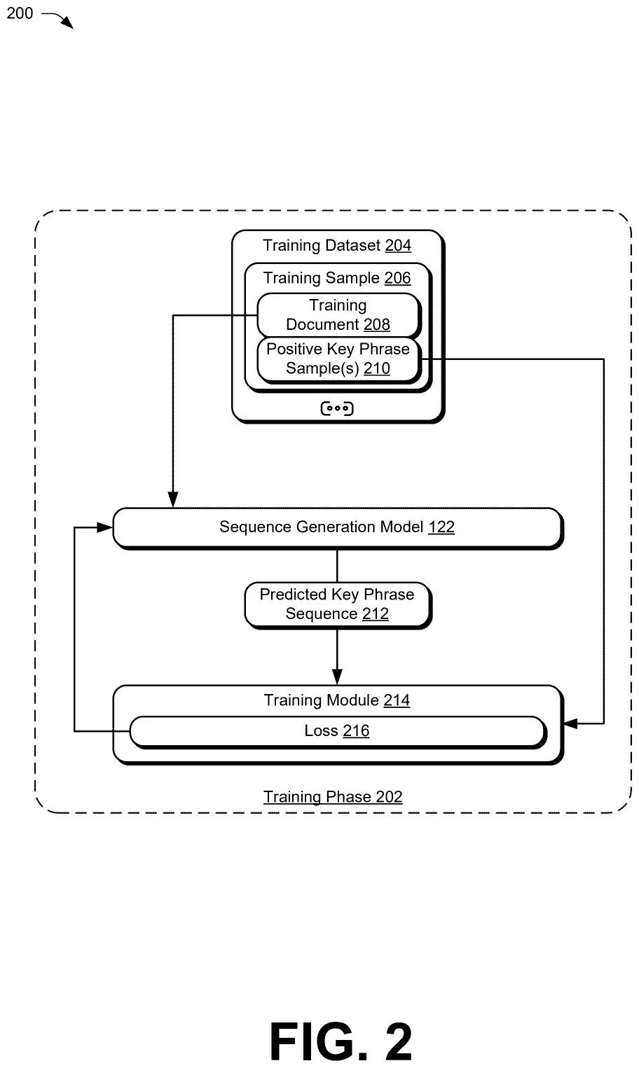

In some implementations, the sequence generation model 122 can be specifically designed to handle text-based input, e.g., of the input document 120. However, in some variations, the sequence generation model 122 can be designed to handle multi-modal input, such as text data, image data, video data, and/or audio data, (e.g., of the input document 120), thereby allowing the sequence generation model 122 to process and generate key phrases for a wider range of input types. The choice of model architecture modality processing capabilities depends on factors such as the specific requirements of the application, the nature and volume of available training data, and computational resources. Regardless of the specific implementation, the sequence generation model 122 is designed to generate a sequence of relevant key phrases based on the input document 120. A training process for training the sequence generation model 122 is discussed in more detail below with reference to FIGS. 2-4.

In general, the sequence generation model 122 is programmed with a threshold key phrase count 124, as well as a threshold token count 126. In accordance with the described techniques, the sequence generation model 122 processes the input document 120 to generate a key phrase sequence 128 having a plurality of key phrases 130. As part of this, the sequence generation model 122 generates tokens (e.g., start tokens 132, content tokens 134, and end tokens 136) sequentially, with previously generated tokens of the key phrase sequence 128 being used as context for tokens being generated in an autoregressive manner.

More specifically, the key phrase recommendation system 106 receives the input document 120, and in various implementations, preprocesses the input document 120 to enhance conciseness and reduce processing latency. This preprocessing step may involve truncating or cleaning up lengthy portions of the input document 120, such as item descriptions, to conserve tokens and optimize inference time. For instance, in an e-commerce context, the key phrase recommendation system 106 may retain an item title (e.g., of the input document 114 formulated as an item listing) in its entirety while summarizing or extracting key information from an item description.

After preprocessing, the input document 120 is provided to the sequence generation model 122 for encoding. The sequence generation model 122 encodes the input document 120 (e.g., using one or more encoders of the sequence generation model 122) to represent the content of the input document numerically as a vector. This vector representation may capture the semantic meaning of the input document 120, in part, by encoding contextual relationships between words and phrases.

The sequence generation model 122 operates in an autoregressive manner to generate tokens sequentially. As the model generates each token, it uses the previously generated tokens as context for generating subsequent tokens. This allows the sequence generation model 122 to maintain coherence and relevance throughout the key phrase sequence 128.

To generate a key phrase 130, the sequence generation model 122 first produces a start token 132, which marks the beginning of the key phrase 130. The start token 132 serves as an indicator to the sequence generation model 122 that a new key phrase 130 is being generated. Following the start token 132, the sequence generation model 122 generates one or more content tokens 134. These content tokens 134 form the actual substance of the key phrase 130, representing individual words of the key phrase 130, in some examples. Note that the key phrase 130 can include a single content token 134 or multiple content tokens 134, e.g., the key phrase 130 can be a single word or a phrase of multiple words. Moreover, the sequence generation model 122 generates an end token 136 to signify the completion of the key phrase. It should be noted that the start token 132 and the end token 136 are different tokens, as opposed to a single separator token that could mark the beginning or the end of a key phrase.

At each token generation step, the sequence generation model 122 generates logits, which are the raw, unnormalized output values produced by a last layer of the sequence generation model 122, e.g., before an activation function. The logits (e.g., raw output values or scores) are distributed across a vast vocabulary of tokens, e.g., words or start/end tokens 132, 136 that are possible next tokens in the key phrase sequence 128 generatable by the sequence generation model 122. In one or more implementations, a logits processor is employed to modify or filter the logits, before a next token selection is made. Then, an activation function is applied to the modified or filtered logits to produce a probability distribution across at least some tokens in the vocabulary. In the probability distribution, probability scores range from zero and one for individual tokens, and the total probability sums to one across all tokens represented in the probability distribution. In some examples, the sequence generation model 122 generates, as the next token in the key phrase sequence 128, the token having a highest probability among the tokens represented in the probability distribution.

The sequence generation model 122 continues this process, generating multiple key phrases 130 in succession, each with its own start token 132, content token(s) 134, and end token 136. In this way, a start token 132 and an end token 136 of a key phrase 130 delineate the key phrase 130 from other key phrases 130 in the key phrase sequence 128. This sequential generation allows the model to produce a coherent and contextually relevant series of key phrases 130 based on the input document 120.

In accordance with the described techniques, the sequence generation model 122 omits use of a self-generated sequence termination token during generation of the key phrase sequence 128. A self-generated sequence termination token, typically used by conventional sequence generation models, is a token generated by the sequence generation model 122 that signals the end of the entire key phrase sequence 128 generation task. This special token is “self-generated” in the sense that the token is output directly by the model architecture, as opposed to some external mechanism, e.g., a logits processor. This token is omitted in the sense that the sequence generation model 122's token vocabulary (e.g., the tokens that the model can predict) does not include a sequence termination token. By omitting this token, the sequence generation model 122 is able to perceive the key phrase sequence 128 generation as an indefinite or infinite task, allowing it to continue generating key phrases 130 indefinitely without self-terminating.

To manage the generation process, the logits processor is employed. After the sequence generation model 122 generates an end token 136 for a key phrase 130, the logits processor causes the sequence generation model 122 to begin a new key phrase 130 by generating a start token 132. The logits processor maintains a count of the end tokens 136 generated in the key phrase sequence 128. This count serves as a mechanism to track the number of complete key phrases 130 that have been generated. In one or more implementations, the logits processor compares this count to the threshold key phrase count 124, which represents the desired number of key phrases to be generated. When the count of end tokens 136 reaches the threshold key phrase count 124, the logits processor intervenes to terminate the key phrase sequence 128 generation task. This approach allows the system to generate a controlled number of key phrases 130 while leveraging the sequence generation model 122's ability to perceive the task as indefinite during the generation process.

Once the key phrase sequence 128 is generated, recommended key phrases 138 (of the key phrase sequence 128) are communicated to the computing device 102 of a publisher of the input document 120, and the computing device 102 displays the recommended key phrases 138 in a user interface of the application 110. That is, the key phrase recommendation system 106 outputs the key phrases 130 of the key phrase sequence 128 as recommended key phrases 138 for the input document 120. In an e-commerce context, for instance, a seller publishes a listing (e.g., the input document 120) via the online marketplace, and in response, the key phrase recommendation system 106 processes the input document 120 in accordance with the described techniques. Moreover, the key phrase recommendation system 106 outputs the key phrase sequence 128 as recommended key phrases 138 for display to the seller that published the listing. In this context, the recommended key phrases 138 may represent query terms that the seller can bid on in order to promote the listing (e.g., move the listing to a more prominent position in a search results page) when the recommended key phrase 138 is searched via the search platform 118.

In some cases, it is observed that the key phrases 130 that are searched by users via the search platform 118 are short, e.g., less than five tokens in length. Due to this, the sequence generation model 122 is programmed with the threshold token count 126, which specifies a maximum number of content tokens 134 to include in each key phrase 130. For example, the logits processor counts the number of content tokens 134 of a key phrase 130, e.g., following a previous start token 132 in the sequence. If the count of content tokens 134 reaches the threshold token count 126, then the logits processor causes the sequence generation model 122 to insert an end token 136. That is, the sequence generation model 122 is configured to insert an end token 136 to terminate generation of a key phrase 130 after a threshold number of content tokens 134 are generated for the key phrase 130.

It should be noted that, unlike a self-generated sequence termination token, the sequence generation model 122 is configured to self-generate the end tokens 136 in some cases. For example, if the sequence generation model 122 determines that a key phrase 130 should terminate before the threshold token count 126 of content tokens 134 is reached, the sequence generation model 122 does self-generate the end token 136. However, when the sequence generation model 122 determines to generate more than the threshold token count 126 of content tokens 134, the logits processor intervenes and forces insertion of an end token 136 to terminate the key phrase 130.

Conventional techniques for key phrase recommendation typically employ sequence generation models that use a self-generated sequence termination token to signal the end of key phrase generation. These models are often trained on datasets with inherent biases, such as self-selection bias in data annotation processes. In the context of an online marketplace, for instance, a listing (e.g., a document 114) is paired with a key phrase in the training data if the listing is engaged with (e.g., clicked) at least a threshold number of times in response to the key phrase being search via the search platform 118. While unpopular item listings make up a majority of the online marketplace, unpopular items typically receive sufficient engagement to be paired with just one key phrase in the training data. Thus, a key phrase may not be paired with a document in the training data (despite being relevant to the document) because it is buried behind more popular items within the search results, and as such, does not receive sufficient engagement to be paired with the key phrase.

Conventional sequence generation models inherit this popularity/self-selection bias of the training data on which they are trained. Since conventional sequence generation models are configured to self-generate the sequence termination token, for instance, they learn to generate the sequence termination token prematurely, e.g., after only one or a few generated key phrases. This is because the training data typically includes a limited number (e.g., one or two) key phrases before the sequence of key phrases is terminated. This is true, despite the notion that, in practice, users prefer to receive many (e.g., ten to twenty) recommended key phrases 138 to choose from, and potentially bid on, to gain exposure of documents 114 that the users publish via the digital services 112. In summary, conventional models exhibit an early-termination problem based on these models' reliance on the self-generated sequence termination token, which is often triggered too soon based on the biased training data.

In contrast, the described techniques employ a sequence generation model that is configured to omit the use of a self-generated sequence termination token during the generation of the key phrase sequence. By removing this token, the sequence generation model 122 is able to perceive the key phrase generation task as indefinite. As further discussed below with reference to FIGS. 2-4, this approach overcomes the biased training data by training the sequence generation model 122 to produce outputs that reflect the biased training data, while relying on the sequence generation model 122's ability to generalize in order to increase the number of key phrases 130 beyond what is typically seen during training. This enables the sequence generation model 122 to generate a more comprehensive and diverse set of relevant key phrases 130 in the key phrase sequence 128, thereby improving the overall quality of recommended key phrases 138.

Having considered an example of an environment, consider now a discussion of some example details of the techniques for graph-directed key phrase generation using indefinite sequence learning similarity in accordance with one or more implementations.

FIG. 2 depicts a system 200 showing operation of a key phrase recommendation system 106 during a training phase 202. In the system 200, the key phrase recommendation system 106 is configured to formulate a training dataset 204 that includes a plurality of training samples 206. Each training sample 206 includes a training document 208 (of the documents 114) paired with one or more positive key phrase samples 210. Generally, a training document 208 is paired with a positive key phrase sample 210 in the training dataset based on historical engagement with the training document 208 in response to the positive key phrase sample 210 being searched via the search platform 118.

For example, in addition to maintaining the documents 114 themselves, the storage device 116 maintains query data (e.g., search logs) in various implementations. The query data includes, for instance, key phrases (user queries or portions thereof) searched via the search platform 118, and documents 114 engaged with when respective key phrases are searched. Engagement with a document 114 is definable in any one or more of a variety of ways. In an e-commerce context, for instance, an item listing (e.g., a document 114) is engaged with when the item listing is clicked, purchased, bid on, added to cart, viewed, and so on. Thus, a key phrase is defined as co-occurring with a document 114 if the document 114 is engaged with in a search results page that is surfaced by searching the key phrase via the search platform 118. Here, a document 114 and a key phrase are paired together as a training sample 206 (e.g., a training document 208 and a positive key phrase sample 210) if the search logs include at least a threshold number of co-occurrences between the document 114 and the key phrase.

Broadly speaking, the sequence generation model 122 receives the training document 208 of the training sample 206, and processes the training sample 206 to generate a predicted key phrase sequence 212 in accordance with the described techniques. Moreover, the predicted key phrase sequence 212 is provided to a training module 214 along with the positive key phrase sample(s) 210 of the training sample 206. The training module 214 is configured to determine a loss 216 (e.g., using a loss function, such as cross-entropy loss) based on a comparison of the predicted key phrase sequence 212 and the positive key phrase sample(s) 210. Based on the loss 216, the training module 214 updates parameters (e.g., internal weights) of the sequence generation model 122 to minimize the loss 216. This process is repeated on a plurality of training samples 206 during the training phase 202 until a threshold number of training samples 206 have been processed, a threshold number of epochs have been processed, or the loss 216 converges to a minimum.

More specifically, the sequence generation model 122 receives a training document 208 of a training sample 206. The positive key phrase samples 210 of the training sample 206 are represented as a ground truth sequence of tokens. For example, the ground truth sequence of tokens includes start tokens and end tokens separating key phrases, and content tokens representing words of the positive key phrase samples 210. As previously mentioned, the sequence generation model 122 generates tokens of the predicted key phrase sequence 212 sequentially in an autoregressive manner. At each token generation step during the training phase, the training module 214 generates a per-token loss.

The per-token loss measures the difference (e.g., cross-entropy loss) between a predicted probability distribution vector output by the sequence generation model 122 at the token generation step, and a one-hot encoding representing the correct next token of the ground truth sequence of tokens. Generally, the probability distribution vector includes values (e.g., between one and zero, normalized to a sum of one) assigned to different vector positions representing different tokens (of a vocabulary or library of tokens) that can be predicted by the sequence generation model 122. Similarly, the one-hot encoding is a vector including vector positions representing the different tokens (of a vocabulary or library of tokens), but all vector positions are assigned a value of zero besides the vector position representing the correct next token of the ground truth sequence (which is assigned a value of one).

During the training phase 202, the sequence generation model 122 is configured to omit use of the self-generated sequence termination token. That is, the vocabulary of tokens that can be predicted by the sequence generation model 122 does not include a sequence generation token, and the training samples 206 (e.g., the ground truth sequence of tokens) do not include sequence termination tokens. In this way, the sequence generation model 122 does not learn to self-generate a sequence termination token. Rather, per-token loss calculation occurs at each token generation step until the training module 214 runs out of ground truth tokens in the ground truth sequence of tokens. Consider an example in which the ground truth sequence of tokens includes ten tokens. In this example, the training module 214 compares the generated tokens of the predicted key phrase sequence 212 sequentially, token-by-token, to corresponding tokens of the ground truth key phrase sequence, calculating the per-token loss at each token generation step. After the tenth (e.g., last) per-token loss is calculated, the loss calculation process terminates. Thus, the loss 216 for a training sample 206 is a combination (e.g., sum or weighted sum) of the per-token losses calculated at each token generation step.

By eliminating the sequence termination token from the training phase 202, the training phase 202 is framed as a positive-unlabeled sequence learning task. For example, the tokens in the positive key phrase sample(s) 210 are treated as positive samples, with the parameters of the sequence generation model 122 being adjusted to produce outputs that reflect the positive samples. However, the vast vocabulary or library of tokens that are predictable by the sequence generation model 122 (which are not included in the positive key phrase samples) are treated as unlabeled samples. That is, the unlabeled samples are neither positive nor negative, thereby causing the sequence generation model 122 to perceive the unlabeled samples as potentially correct (or positive). This, in combination with the omission of the self-generated sequence termination token, causes the sequence generation model 122 to learn to perceive key phrase generation task as indefinite. In other words, but for the logits processor mentioned above, the sequence generation model 122 is designed to sequentially generate key phrases indefinitely. In some implementations, the vocabulary or library of tokens that are generatable by the sequence generation model 122 are not limited to a predefined dataset, but instead, include any token (word, character, number) that the sequence generation model 122 can output in accordance with its natural language processing capabilities.

By training the sequence generation model 122 in this manner, the described techniques are able to overcome deficiencies in the training dataset 204 which suffer from the self-selection/popularity bias mentioned above. By training the sequence generation model 122 on the positive key phrase samples 210 that are paired with the training document 208 based on engagement data, the sequence generation model 122 learns to generate key phrases that are likely to produce engagement with a given input document 120. Moreover, by removing the self-generated sequence termination token, the sequence generation model 122 learns to generate more key phrases than the number of positive key phrase samples 210 typically represented in a training sample. Furthermore, the sequence generation model 122 uses its autoregressive functionality and natural language processing capabilities to generalize to unseen data, e.g., generating key phrases that were not exposed to the sequence generation model 122 during training, but are still relevant to the input document 120.

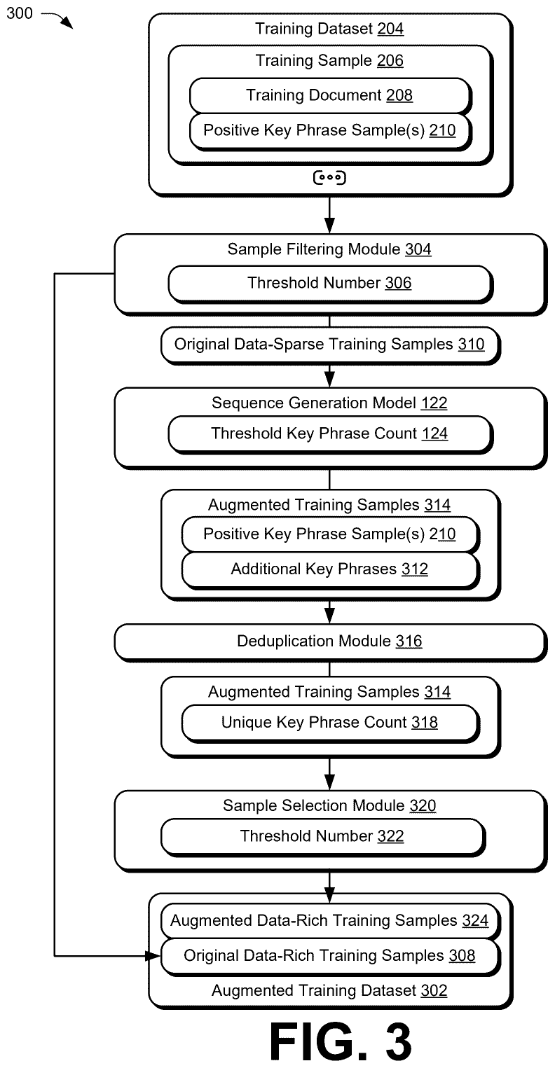

FIG. 3 depicts a system 200 showing operation of a key phrase recommendation system 106 to generate an augmented training dataset 302. In the system 300, the training dataset 204 is received by a sample filtering module 304, which is programmed with a threshold number 306. Generally, the sample filtering module 304 is configured to distinguish between original data-rich training samples 308 and original data-sparse training samples 310. The original data-rich training samples 308 correspond to the training samples 206 of the training dataset 204 which have at least the threshold number 306 of positive key phrase samples 210. In contrast, the original data-sparse training samples 310 correspond to the training samples 206 of the training dataset 204 that have fewer than the threshold number 306 of positive key phrase samples 210. As shown, the sample filtering module 304 filters the training samples 206 by selecting the original data-rich training samples 308 (of the training samples 206) for inclusion in the augmented training dataset 302, and passing the original data-sparse training samples 310 along for further processing by the sequence generation model 122.

In particular, the sequence generation model 122 of the system 300 is a version of the sequence generation model 122 that has been trained during the training phase 202, e.g., a trained sequence generation model 122. Here, the sequence generation model 122 is configured to process each of the original data-sparse training samples 310 to generate additional key phrases 312 for each of the original data-sparse training samples 310. To do so, the sequence generation model 122 operates similarly to the manner described above with respect to FIG. 1. To generate the additional key phrases 312 for an original data-sparse training sample 310, for instance, the trained sequence generation model 122 processes the training document 208 of the original data-sparse training sample 310 to generate a key phrase sequence 128. In doing so, the logits processor of the sequence generation model 122 is employed to enforce the threshold key phrase count 124, causing termination of the key phrase generation task when the number of key phrases reaches the threshold key phrase count 124. The additional key phrases 312 of the original data-sparse training sample 310 include the key phrases of the generated key phrase sequence 128. Further, the original data-sparse training sample 310 is converted to an augmented training sample 314 that includes the original positive key phrase samples 210, as well as the additional key phrases 312. This process is repeated for each original data-sparse training sample 310 to generate a plurality of augmented training samples 314.

In one or more implementations, the augmented training samples 314 are provided to a deduplication module 316. Given an augmented training sample 314, the deduplication module 316 counts the number of unique key phrases across the positive key phrase sample(s) 210 and the additional key phrases 312, e.g., a unique key phrase count 318. In other words, if there is a duplicated key phrase in a combined set of the positive key phrase samples 210 and the additional key phrases 312, the deduplication module 316 deduplicates the key phrase and counts it just once toward the unique key phrase count 318. This process is repeated for each augmented training sample 314 to generate a unique key phrase count 318 for each augmented training sample 314.

The augmented training samples 314 having the unique key phrase counts 318 are provided to a sample selection module 320, which is programmed with a threshold number 322. Here, the sample selection module 320 is configured to select augmented data-rich training samples 324 (from among the augmented training samples 314) for inclusion in the augmented training dataset 302. The augmented data-rich training samples 324 are the augmented training samples 314 having a unique key phrase count 318 that meets or exceeds the threshold number 322, e.g., which may be a same or different number as the threshold number 306. Other augmented training samples 314 having the unique key phrase counts 318 that fall below the threshold number 322 are discarded, e.g., not included in the augmented training dataset 302.

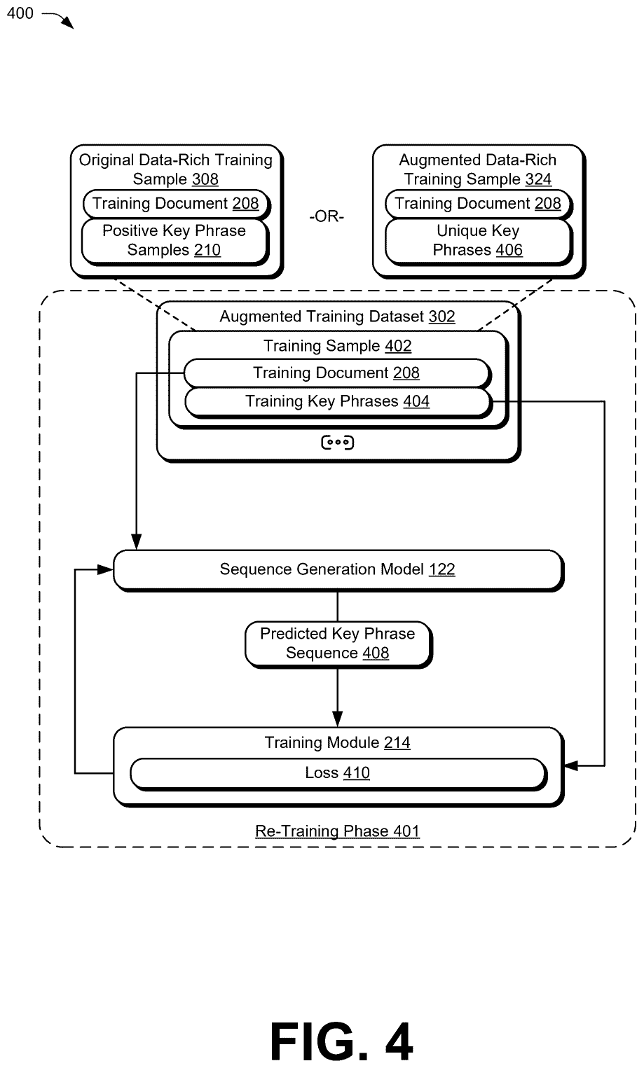

FIG. 4 depicts a system 400 showing operation of a key phrase recommendation system 106 during a re-training phase 401. For example, the sequence generation model 122 (e.g., after having been trained during the training phase 202) is re-trained on the augmented training dataset 302 during the re-training phase 401. The re-training phase 401 operates similarly to the training phase 202, but using different and/or augmented data.

Here, the augmented training dataset 302 includes a plurality of training samples 402, and each training sample 402 includes a training document 208 and a plurality of training key phrases 404. Each training sample 402 is either an original data-rich training sample 308 or an augmented data-rich training sample 324. An original data-rich training sample 308 includes, as the training key phrases 404, the positive key phrase samples 210 associated with the sample in the original training dataset 204. In contrast, an augmented data-rich training sample 324 includes, as the training key phrases 404, unique key phrases from a combined set of the one or more positive key phrase samples 210 (of the original training dataset) and the additional key phrases 312 generated for the augmented data-rich training sample 324. Consider an example in which an augmented data-rich training sample 324 includes the positive key phrase samples 210 “gaming headphones” and “Bluetooth,” and the additional key phrases 312 “gaming headphones,” “Echo headphones,” “Echo Forge,” and “Echo Headphones.” In this example, the unique key phrases 406 of the augmented data-rich training sample 324 includes “gaming headphones,” “Bluetooth,” “Echo Forge,” and “Echo Headphones.”

To re-train the sequence generation model 122, the sequence generation model 122 receives the training document 208 of a training sample 402, and processes the training sample 402 to generate a predicted key phrase sequence 408 in accordance with the described techniques. Moreover, the predicted key phrase sequence 408 is provided to a training module 214 along with the training key phrases 404 of the training sample 402. The training module 214 is configured to determine a loss 410 (e.g., using a loss function, such as cross-entropy loss) based on a comparison of the predicted key phrase sequence 408 and the unique key phrases 406. Based on the loss 410, the training module 214 updates parameters (e.g., internal weights) of the sequence generation model 122 to minimize the loss 410. This process is repeated on a plurality of training samples 402 during the re-training phase 401 until a threshold number of training samples 402 have been processed, a threshold number of epochs have been processed, or the loss 410 converges to a minimum.

More specifically, as discussed in more detail above, the training module 214 generates a loss 410 for each training sample 402 by computing per-token losses at each token generation step. The sequence generation model 122 processes the training document 208 to generate a predicted key phrase sequence 408, while the training key phrases 404 are represented as a ground truth sequence of tokens. At each step, the sequence generation model 122 outputs a probability distribution over possible next tokens. This distribution is compared to a one-hot encoding of the correct next token from the ground truth sequence, e.g., using a cross-entropy loss function. Notably, the sequence generation model 122 is configured to omit use of a self-generated sequence termination token during the re-training phase 401. The per-token losses are calculated sequentially until the ground truth sequence is exhausted. The overall loss 410 for the training sample 402 is then computed as a combination (e.g., sum or weighted sum) of these individual per-token losses.

As previously mentioned, the training dataset 204 exhibits the self-selection/popularity bias discussed in detail above. That is, many training samples 206 in the original training dataset 204 include only one or a few positive key phrase samples 210 due to the manner in which the training dataset 204 is curated, e.g., based on engagement data. Due to this, the sequence generation model 122 (trained solely on the original training dataset 204 during the training phase 202) may learn to generate duplicated key phrases in the key phrase sequence 128. For example, removal of the self-generated sequence token causes the sequence generation model 122 to continuously generate key phrases, but the small number of positive key phrase samples 210 in the training dataset 204 often causes the sequence generation model 122 to re-generate the same key phrase.

By implementing the re-training phase 401 using the augmented training dataset 302, the described techniques address this duplication issue and enhance the sequence generation model 122's performance at generating diverse and relevant key phrases. The augmented training dataset 302, which combines original data-rich training samples 308 with augmented data-rich training samples 324, exposes the sequence generation model 122 to a broader range of key phrases for each training document 208. This expanded vocabulary allows the sequence generation model 122 to learn more diverse associations between documents and relevant key phrases. As a result, during inference, the re-trained sequence generation model 122 is capable of generating a more numerous and diverse set of recommended key phrases 138 for a given input document 120. This improvement in key phrase diversity and quantity enhances the overall quality and usefulness of the recommended key phrases 138, providing users with a richer set of options for tasks such as search engine optimization or content tagging.

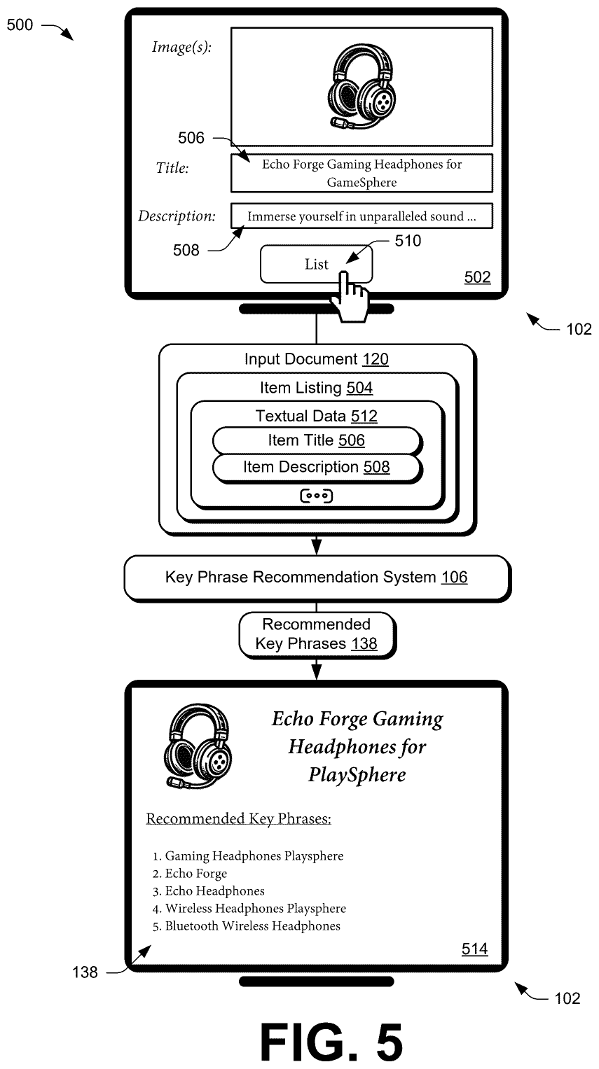

FIG. 5 is an example 500 showing user interfaces displayable in accordance with the described techniques. In the example 500, the computing device 102 displays a user interface 502. In particular, the example 500 is depicted and described in an online marketplace context, and as such, the user interface 502 is a user interface of an application 110 of the online marketplace. The user interface 502 includes input areas via which the user has input various information (e.g., attributes) associated with an item listing 504, such as one or more images of the item, an item title 506, and an item description 508. As shown at 510, the user provides input selecting a user interface element, and the selection causes the item listing to be published via the online marketplace.

In response to the user selection, item listing 504 is communicated to the key phrase recommendation system 106 as an input document 120, which generates the recommended key phrases 138 for the item listing 504 in accordance with the described techniques. While not to be construed as limiting, the sequence generation model 122 of the example 500 is configured as a text-based model, designed and/or trained to handle text-based inputs. Thus, in this example 500, the sequence generation model 122 is conditioned on textual data 512 of the item listing 504, e.g., including the item title 506 and the item description 508. It is to be appreciated that the textual data 512 of the item listing 504 can be extended to include additional sources of textual information associated with the item listing in various implementations.

As shown, the recommended key phrases 138 are communicated back to the computing device 102. This causes the computing device 102 to display a user interface 514 of the application 110 that includes the recommended key phrases 138 of the key phrase sequence 128. In one or more implementations, the user may select individual key phrases of the recommended key phrases 138 to initiate a process for bidding on the recommended key phrase 138, e.g., for the purpose of promoting the item listing when the recommended key phrase 138 is searched via the search platform 118.

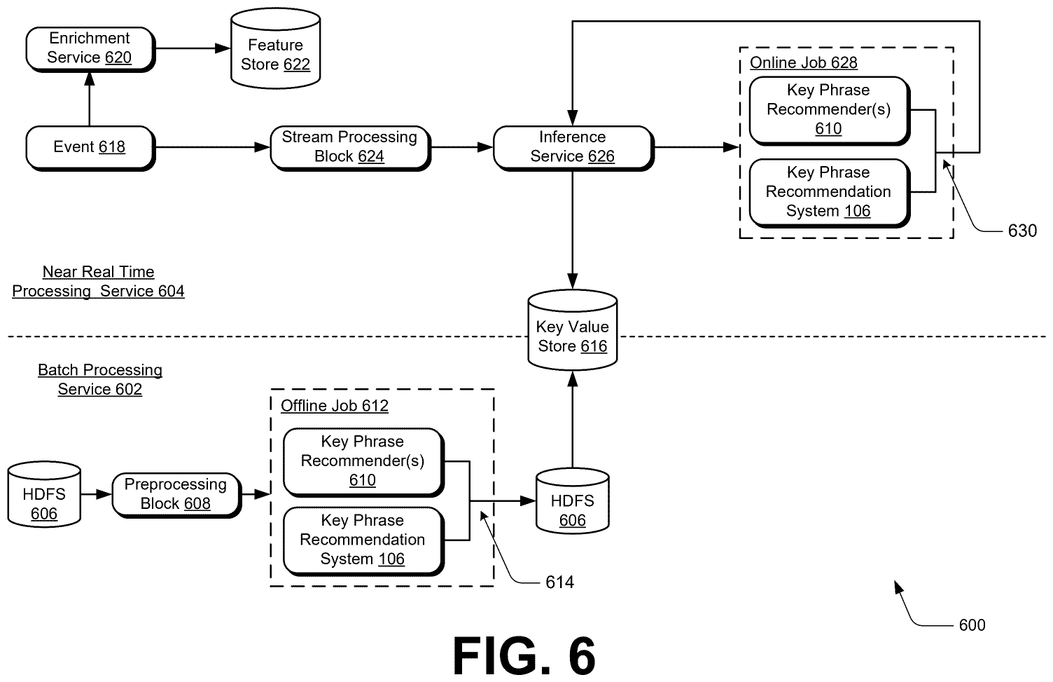

FIG. 6 is an example 600 of a serving architecture that is operable to employ techniques described herein. The example 600 includes a batch processing service 602, which is generally configured to periodically process documents 114 published online via the search platform 118 using the key phrase recommendation system 106. For example, the batch processing service 602 periodically (e.g., daily) determines the recommended key phrases 138 for all documents 114 published online via the search platform 118. Additionally or alternatively, the batch processing service 602 performs a daily differential. That is, the batch processing service 602 periodically (e.g., daily) determines the recommended key phrases 138 for all documents 114 that are newly published during a previous time period, and all documents 114 that are updated/revised during the previous time period. The example 600 also includes a near real time processing service 604, which generates the recommended key phrases 138 urgently (e.g., in near real time) for a document 114 responsive to a new document 114 being published or an existing document 114 being updated.

In accordance with the batch processing service 602, the raw data of the documents 114 are stored in a Hadoop Distributed File System (HDFS) 606. This data is processed by a preprocessing block 608 which is generally configured to perform one or more preprocessing operations on the raw data to format the data in a way that is processable by the key phrase recommendation system 106. In some examples, the preprocessing block 608 preprocesses a document 114 by truncating or cleaning up lengthy portions of the document to reduce token count and optimize inference time. The preprocessed data is provided as input to the key phrase recommendation system 106 and one or more key phrase recommenders 610. Broadly, the key phrase recommenders 610 are models and/or algorithms that generate key phrase recommendations using techniques and/or methods that differ from the key phrase recommendation system 106. In particular, the generation of recommended key phrases 138 is performed as part of an offline job 612, meaning that the computations are performed by a web services platform external to the service provider system 104. For example, the offline job 612 is performed by a data stream processing platform, such as Apache Flink.

As shown at 614, the results of the processing by the key phrase recommender(s) 610 and the key phrase recommendation system 106 are merged, and then stored in the HDFS 606. Once the data is fully processed (e.g., all documents 114 are processed or all updated documents 114 are processed), the data is stored in a key value store 616. For example, the document 114 is the “key” of an entry in the key value store, while the recommended key phrases 138 for the item document 114 are the “values” of the entry in the key value store.

In accordance with the near real time processing service 604, an event 618 is received defining a new document 114 being published or an update to an existing document 114. The raw data of the event 618 is provided to an enrichment service 620, which generally is configured enrich the raw data (e.g., to segment the data into attributes, such as an item title and an item description for an item listing), and store the enriched data in a feature store 622. In addition, the event 618 is processed by a stream processing block 624, e.g., an Apache Flink processing window. Examples of operations performable by the stream processing block 624 include grouping events 618 by time window (e.g., grouping the events 618 received within a time interval) or count window (e.g., grouping a fixed number of events 618), and filtering (i.e., removing) irrelevant events 618, e.g., update events 618 in which the updated data does not impact key phrase recommendations.

After being processed by the stream processing block 624, the event 618 triggers calling of an inference service 626, which is a machine learning inference service of the service provider system 104 designed to handle real-time data processing and model inference at scale. In particular, the inference service 626 processes the newly listed or updated document 114 as an online job 628 (e.g., the processing is performed by hardware resources of the service provider system 104) using the key phrase recommender(s) 610 and the key phrase recommendation system 106. As shown at 630, the results of the processing are merged, and the inference service 626 stores the results in the key value store 616. For instance, the inference service 626 updates the key value store 616 to include a new entry (e.g., for a newly published document 114) or updates an entry in the key value store 616, e.g., for an updated document 114.

In other words, both the batch processing service 602 and the near real time processing service 604 inject data (e.g., documents 114 and corresponding recommended key phrases 138) in the key value store 616. Recommended key phrases 138 are served (e.g., surfaced in user interfaces) to users of the digital services 112 from the key value store 616. Notably, the serving architecture depicted in the example 600 is highly scalable, e.g., to billions of documents 114 and hundreds of billions of key phrases.

Having discussed exemplary details of key phrase recommendation based on token correspondence, consider now some examples of procedures to illustrate additional aspects of the techniques.

### Example Procedures

This section describes examples of procedures for graph-directed key phrase recommendation based on item similarity. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

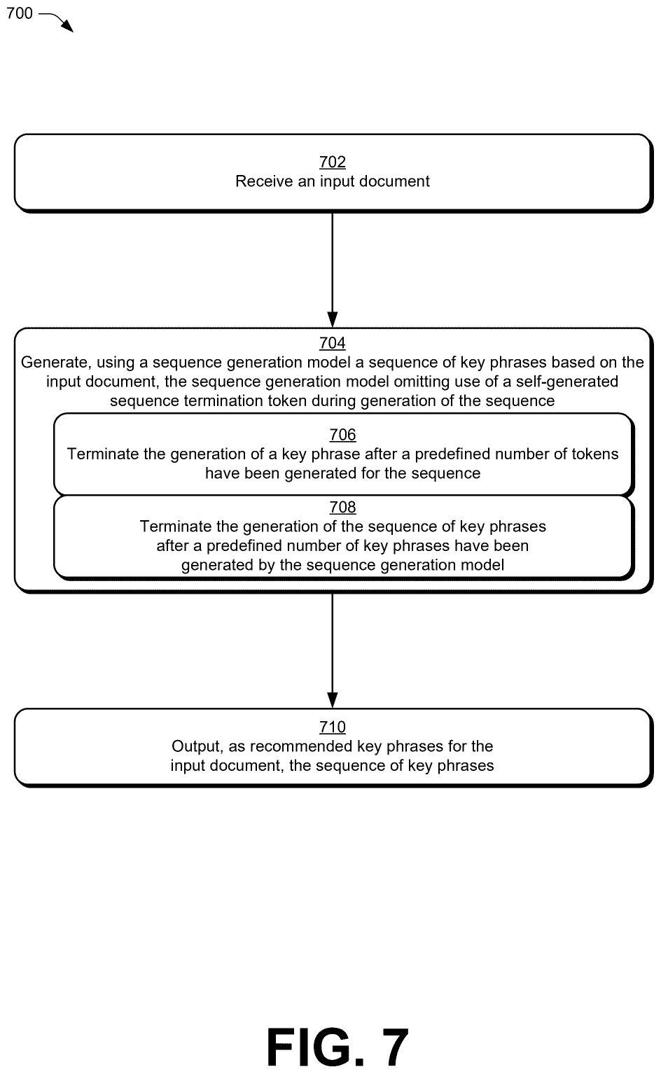

FIG. 7 depicts a procedure 700 in an example implementation of key phrase generation using indefinite sequence learning. In the procedure, an input document is received (block 702). By way of example, the key phrase recommendation system 106 receives an input document 120.

A sequence of key phrases is generated based on the input document using a sequence generation model, and the sequence generation model omits use of a self-generated sequence termination token during generation of the sequence (block 704). For instance, the sequence generation model 122 processes the input document 120 to generate a key phrase sequence 128. The sequence generation model 122 generates key phrases 130 of the key phrase sequence 128 sequentially, token-by-token, in an autoregressive manner. That is, at each token generation step, the sequence generation model 122 generates a token, while using previously generated tokens of the sequence as context. The sequence generation model 122 is trained and/or configured to omit use of a self-generated sequence termination token.

For example, the key phrase recommendation system 106 is configured to remove a sequence termination token from the sequence generation model 122's vocabulary, e.g., the collection of tokens that are possibly generatable by the sequence generation model 122. Additionally or alternatively, the architecture of the sequence generation model 122 is modified to prevent generation of such a token. Moreover, the ground truth key phrase sequences (e.g., formed from the positive key phrase samples 210 and/or the training key phrases 404) do not include sequence termination tokens. By omitting the sequence termination token from the training data, the sequence generation model 122 learns to avoid generating such a token during inference, thereby perceiving the sequence generation task as indefinite and continuously generating key phrases until an external mechanism terminates the key phrase generation task. That is, during inference, the sequence generation model 122 generates key phrases continuously without self-generating a sequence termination token, and instead relies on an external mechanism (e.g., the logits processor) to terminate the key phrase generation task when the threshold key phrase count 124 is reached, as described below.

As part of the sequence generation task, the generation of a key phrase is terminated after a predefined number of tokens have been generated for the sequence (block 706). For example, the sequence generation model 122 generates each key phrase 130 by producing a start token 132, followed by one or more content tokens 134, and an end token 136. In some implementations, the sequence generation model 122 self-generates the end token 136 to mark the end of a key phrase 130. However, the logits processor of the sequence generation model 122 enforces a threshold token count 126, inserting an end token 136 if the number of content tokens 134 in the key phrase 130 reaches this threshold.

Additionally, as part of the sequence generation task, the generation of the sequence of key phrases is terminated after a predefined number of key phrases have been generated by the sequence generation model (block 708). For example, the logits processor maintains a count of end tokens 136 of the key phrase sequence 128, which signifies the number of generated key phrases 130 of the key phrase sequence 128. Furthermore, the logits processor terminates the key phrase termination task in response to the number of generated key phrases 130 of the key phrase sequence 128 having reached the threshold key phrase count 124.

The generated sequence of key phrases is output as recommended key phrases for the input document (block 710). For instance, the key phrase recommendation system 106 outputs the key phrases 130 of the key phrase sequence 128 as recommended key phrases 138.

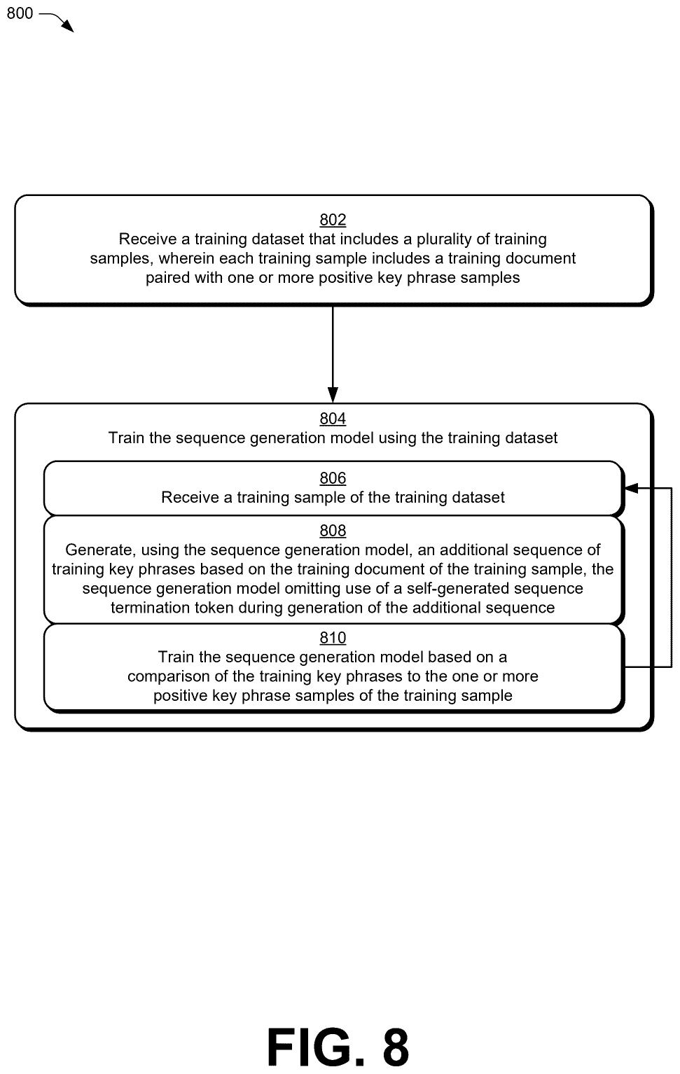

FIG. 8 depicts a procedure 800 for training a sequence generation model in accordance with one or more implementations. In the procedure 800, a training dataset is received that includes a plurality of training samples, with each training sample including a training document paired with one or more positive key phrase samples (block 802). By way of example, the key phrase recommendation system 106 receives a training dataset 204 containing multiple training samples 206, where each training sample 206 includes a training document 208 paired with one or more positive key phrase samples 210. A positive key phrase sample 210 is paired with a training document 208 as a training sample 206 based on historical engagement with the training document 208 responsive to the positive key phrase sample 210 being searched (as a user query or portion thereof) via the search platform 118.

The sequence generation model is trained using the training dataset (block 804), and as part of this, a training sample of the training dataset is received (block 806). For example, the training module 214 trains the sequence generation model 122 during the training phase 202, and as part of this, the sequence generation model 122 receives and processes a training sample 206.

During the training phase, a sequence of training key phrases is generated using the sequence generation model based on the training document of the training sample, and the sequence generation model omits use of a self-generated sequence termination token during generation of the additional sequence (block 808). By way of example, the sequence generation model 122 processes the training document 208 of the training sample 206 to generate a predicted key phrase sequence 212. In particular, the sequence generation model 122 generates training key phrases sequentially, token-by-token, in an autoregressive manner, without using a self-generated sequence termination token.

The sequence generation model is trained based on a comparison of the training key phrases to the one or more positive key phrase samples of the training sample (block 810). For instance, the training module 214 compares the predicted key phrase sequence 212 generated by the sequence generation model 122 to the positive key phrase samples 210 of the training sample 206. The training module 214 calculates a loss 216 based on this comparison, which is used to update the parameters of the sequence generation model 122. As shown, the training process illustrated in blocks 806, 808, 810 is repeated on a plurality of training samples 206 until a stopping criterion is met, such as processing a threshold number of training samples 206, completing a threshold number of epochs, or achieving convergence of the loss 216.

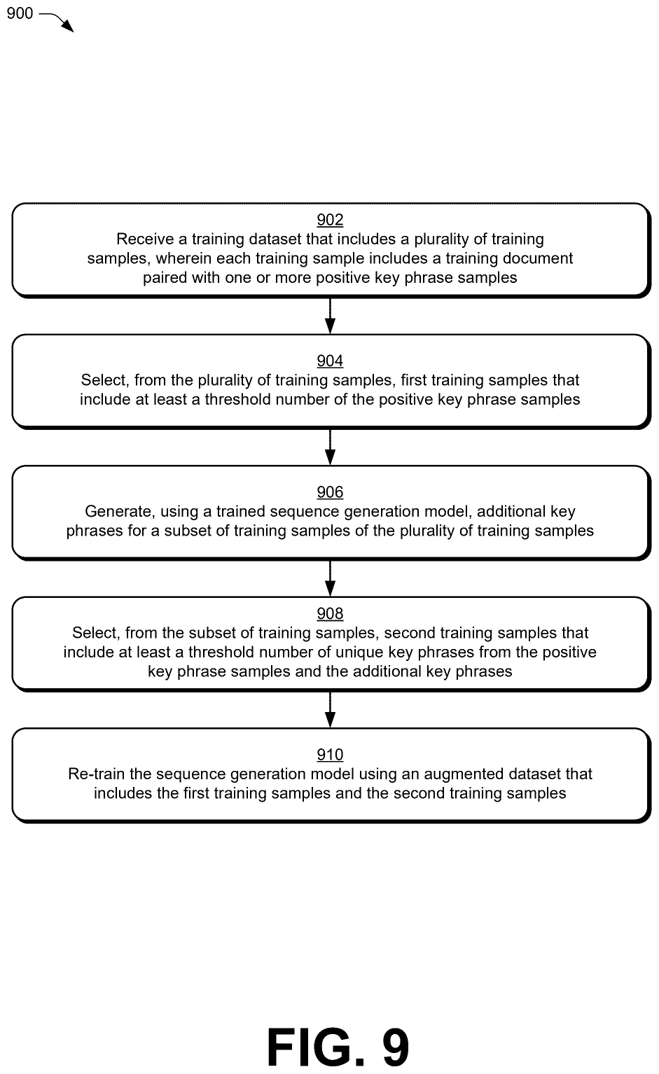

FIG. 9 depicts a procedure 900 for re-training a sequence generation model on an augmented training dataset in accordance with one or more implementations. In the procedure, a training dataset is received that includes multiple training samples, with each training sample including a training document paired with one or more positive key phrase samples (block 902). By way of example, the key phrase recommendation system 106 receives a training dataset 204 containing multiple training samples 206. Each training sample 206 includes a training document 208 paired with one or more positive key phrase samples 210. For instance, a positive key phrase sample 210 is paired with a training document 208 as a training sample 206 based on historical engagement with the training document 208 responsive to the positive key phrase sample 210 being searched via the search platform 118.

First training samples are selected from the plurality of training samples because the first training samples include at least a threshold number of positive key phrase samples (block 904). For example, the sample filtering module 304 selects original data-rich training samples 308 from the training samples 206 of the training dataset 204 for inclusion in the augmented dataset 302. The original data-rich training samples 308 correspond to the training samples 206 which have at least the threshold number 306 of positive key phrase samples 210.

Additional key phrases are generated for a subset of training samples using a trained sequence generation model (block 906). By way of example, the sequence generation model 122 (e.g., having been trained during the training phase 202) processes each of the original data-sparse training samples 310 to generate additional key phrases 312. The original data-sparse training samples 310 correspond to the training samples 206 which have fewer than the threshold number 306 of positive key phrase samples 210. To generate the additional key phrases 312 for an original data-sparse training sample 310, the trained sequence generation model 122 processes the training document 208 of the original data-sparse training sample 310 to generate a key phrase sequence 128, e.g., which includes the additional key phrases 312 for the original data-sparse training sample 310. The original data-sparse training sample 310 is converted to an augmented training sample 314 that includes the positive key phrase samples 210 and the additional key phrases 312.

Second training samples are selected from the subset of training samples based on the second training samples including at least a threshold number of unique key phrases from the positive key phrase samples and the additional key phrases (block 908). For example, the sample selection module 320 selects augmented data-rich training samples 324 from among the augmented training samples 314. The augmented data-rich training samples 324 are the augmented training samples having a unique key phrase count 318 that meets or exceeds a threshold number 322.

The sequence generation model is re-trained using an augmented dataset that combines the first training samples and the second training samples (block 910). For instance, the sequence generation model 122 is re-trained on the augmented training dataset 302 during the re-training phase 401. The augmented training dataset 302 includes the original data-rich training samples 308 and the augmented data-rich training samples 324.

Having described examples of procedures in accordance with one or more implementations, consider now an example of a system and device that can be utilized to implement the various techniques described herein.

### Example System and Device

FIG. 10 illustrates an example of a system generally at 1000 that includes an example of a computing device 1002 that is representative of one or more computing systems and/or devices that may implement the various techniques described herein. This is illustrated through inclusion of the application 110 and the key phrase recommendation system 106. The computing device 1002 may be, for example, a server of a service provider, a device associated with a client (e.g., a client device), an on-chip system, and/or any other suitable computing device or computing system.

The example computing device 1002 as illustrated includes a processing system 1004, one or more computer-readable media 1006, and one or more I/O interfaces 1008 that are communicatively coupled, one to another. Although not shown, the computing device 1002 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware elements 1010 that may be configured as processors, functional blocks, and so forth. This may include implementation in hardware as an application specific integrated circuit or other logic device formed using one or more semiconductors. The hardware elements 1010 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1006 is illustrated as including memory/storage 1012. The memory/storage 1012 represents memory/storage capacity associated with one or more computer-readable media. The memory/storage 1012 may include volatile media (such as random-access memory (RAM)) and/or nonvolatile media (such as read only memory (ROM), Flash memory, optical disks, magnetic disks, and so forth). The memory/storage 1012 may include fixed media (e.g., RAM, ROM, a fixed hard drive, and so on) as well as removable media (e.g., Flash memory, a removable hard drive, an optical disc, and so forth). The computer-readable media 1006 may be configured in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1002. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1002, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1010. The computing device 1002 may be configured to implement particular instructions and/or functions corresponding to the software and/or hardware modules. Accordingly, implementation of a module that is executable by the computing device 1002 as software may be achieved at least partially in hardware, e.g., through use of computer-readable storage media and/or hardware elements 1010 of the processing system 1004. The instructions and/or functions may be executable/operable by one or more articles of manufacture (for example, one or more computing devices 1002 and/or processing systems 1004) to implement techniques, modules, and examples described herein.

The techniques described herein may be supported by various configurations of the computing device 1002 and are not limited to the specific examples of the techniques described herein. This functionality may also be implemented all or in part through use of a distributed system, such as over a “cloud” 1014 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 may include applications and/or data that can be utilized while computer processing is executed on servers that are remote from the computing device 1002. Resources 1018 can also include services provided over the Internet and/or through a subscriber network, such as a cellular or Wi-Fi network.

The platform 1016 may abstract resources and functions to connect the computing device 1002 with other computing devices. The platform 1016 may also serve to abstract scaling of resources to provide a corresponding level of scale to encountered demand for the resources 1018 that are implemented via the platform 1016. Accordingly, in an interconnected device embodiment, implementation of functionality described herein may be distributed throughout the system 1000. For example, the functionality may be implemented in part on the computing device 1002 as well as via the platform 1016 that abstracts the functionality of the cloud 1014.

In some aspects, the techniques described herein relate to a method implemented by at least one computing device, the method including: receiving an input document; generating, using a sequence generation model, a sequence of key phrases based on the input document, the sequence generation model omitting use of a self-generated sequence termination token during generation of the sequence; and outputting, as recommended key phrases for the input document, the sequence of key phrases.

In some aspects, the techniques described herein relate to a method, further including: receiving a training dataset that includes a plurality of training samples, wherein each training sample includes a training document paired with one or more positive key phrase samples; and training the sequence generation model using the training dataset.

In some aspects, the techniques described herein relate to a method, further including pairing the training document with a positive key phrase sample in the training dataset based on historical engagement with the training document in response to the positive key phrase sample being searched via a search platform.

In some aspects, the techniques described herein relate to a method, wherein training the sequence generation model further includes: generating, using the sequence generation model, an additional sequence of training key phrases based on the training document of a training sample, the sequence generation model omitting use of the self-generated sequence termination token during generation of the additional sequence; and training the sequence generation model based on a comparison of the training key phrases to the one or more positive key phrase samples of the training sample.

In some aspects, the techniques described herein relate to a method, further including: selecting, from the plurality of training samples, first training samples that include at least a threshold number of the positive key phrase samples; generating, using the trained sequence generation model, additional key phrases for a subset of training samples of the plurality of training samples; selecting, from the subset of training samples, second training samples that include at least a threshold number of unique key phrases from the positive key phrase samples and the additional key phrases; and re-training the sequence generation model using an augmented dataset that includes the first training samples and the second training samples.

In some aspects, the techniques described herein relate to a method, wherein generating the sequence of key phrases further includes terminating the generation of the sequence of key phrases after a predefined number of key phrases have been generated by the sequence generation model.

In some aspects, the techniques described herein relate to a method, wherein generating a key phrase of the sequence of key phrases further includes: generating a start token that marks a start of the key phrase; and generating an end token that marks an end of the key phrase, wherein the start token and the end token delineate the key phrase from other key phrases of the sequence.

In some aspects, the techniques described herein relate to a method, wherein generating the key phrase further includes inserting the end token of the key phrase in response to generating a threshold number of content tokens for the key phrase.

In some aspects, the techniques described herein relate to a method, wherein the sequence generation model is a transformer-based natural language processing model.

In some aspects, the techniques described herein relate to a system including: one or more processors; and memory storing instructions that, when executed by the one or more processors, cause the system to: receive an input document; generate, using a sequence generation model, a sequence of key phrases based on the input document, the sequence generation model omitting use of a self-generated sequence termination token during generation of the sequence; and output, as recommended key phrases for the input document, the sequence of key phrases.

In some aspects, the techniques described herein relate to a system, wherein the instructions further cause the system to: receive a training dataset that includes a plurality of training samples, wherein each training sample includes a training document paired with one or more positive key phrase samples; and training the sequence generation model using the training dataset.

In some aspects, the techniques described herein relate to a system, wherein the instructions further cause the system to: generate, using the sequence generation model, an additional sequence of training key phrases based on the training document of a training sample, the sequence generation model omitting use of the self-generated sequence termination token during generation of the additional sequence; and train the sequence generation model based on a comparison of the training key phrases to the one or more positive key phrase samples of the training sample.

In some aspects, the techniques described herein relate to a system, wherein the instructions further cause the system to: select, from the plurality of training samples, first training samples that include at least a threshold number of the positive key phrase samples; generate, using the trained sequence generation model, additional key phrases for a subset of training samples of the plurality of training samples; select, from the subset of training samples, second training samples that include at least a threshold number of unique key phrases from the positive key phrase samples and the additional key phrases; and re-train the sequence generation model using an augmented dataset that includes the first training samples and the second training samples.

In some aspects, the techniques described herein relate to a system, wherein the instructions further cause the system to terminate the generation of the sequence of key phrases after a predefined number of key phrases have been generated by the sequence generation model.

In some aspects, the techniques described herein relate to a system, wherein the instructions further cause the system to: generate a start token that marks a start of a key phrase in the sequence of key phrases; and generate an end token that marks an end of the key phrase, wherein the start token and the end token delineate the key phrase from other key phrases of the sequence.

In some aspects, the techniques described herein relate to a system, wherein the instructions further cause the system to insert the end token of the key phrase in response to a threshold number of content tokens having been generated for the key phrase.

In some aspects, the techniques described herein relate to a non-transitory computer-readable storage medium storing instructions that, when executed by one or more processors, cause the one or more processors to perform operations including: receiving an input document; generating a sequence of key phrases based on the input document using a sequence generation model having been trained to generate the key phrases indefinitely; terminating generation of the sequence in response to a threshold number of key phrases having been generated; and outputting the sequence of key phrases.

In some aspects, the techniques described herein relate to a non-transitory computer-readable storage medium, wherein generating the sequence of key phrases further includes omitting use of a self-generated sequence termination token during generation of the sequence.

In some aspects, the techniques described herein relate to a non-transitory computer-readable storage medium, wherein generating a key phrase of the sequence of key phrases further includes: generating a start token that marks a start of the key phrase; and generating an end token that marks an end of the key phrase, wherein the start token and the end token delineate the key phrase from other key phrases of the sequence.

In some aspects, the techniques described herein relate to a non-transitory computer-readable storage medium, wherein generating the key phrase further includes inserting the end token of the key phrase in response to generating a threshold number of content tokens for the key phrase.

### Conclusion

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A method implemented by at least one computing device, the method comprising:
receiving an input document;
generating, using a sequence generation model, a sequence of key phrases based on the input document, the sequence generation model omitting use of a self-generated sequence termination token during generation of the sequence; and
outputting, as recommended key phrases for the input document, the sequence of key phrases.

2. The method of claim 1, further comprising:
receiving a training dataset that includes a plurality of training samples, wherein each training sample includes a training document paired with one or more positive key phrase samples; and
training the sequence generation model using the training dataset.

3. The method of claim 2, further comprising pairing the training document with a positive key phrase sample in the training dataset based on historical engagement with the training document in response to the positive key phrase sample being searched via a search platform.

4. The method of claim 2, wherein training the sequence generation model further comprises:
generating, using the sequence generation model, an additional sequence of training key phrases based on the training document of a training sample, the sequence generation model omitting use of the self-generated sequence termination token during generation of the additional sequence; and
training the sequence generation model based on a comparison of the training key phrases to the one or more positive key phrase samples of the training sample.

5. The method of claim 2, further comprising:
selecting, from the plurality of training samples, first training samples that include at least a threshold number of the positive key phrase samples;
generating, using the trained sequence generation model, additional key phrases for a subset of training samples of the plurality of training samples;
selecting, from the subset of training samples, second training samples that include at least a threshold number of unique key phrases from the positive key phrase samples and the additional key phrases; and
re-training the sequence generation model using an augmented dataset that includes the first training samples and the second training samples.

6. The method of claim 1, wherein generating the sequence of key phrases further comprises terminating the generation of the sequence of key phrases after a predefined number of key phrases have been generated by the sequence generation model.

7. The method of claim 1, wherein generating a key phrase of the sequence of key phrases further comprises:
generating a start token that marks a start of the key phrase; and
generating an end token that marks an end of the key phrase, wherein the start token and the end token delineate the key phrase from other key phrases of the sequence.

8. The method of claim 7, wherein generating the key phrase further comprises inserting the end token of the key phrase in response to generating a threshold number of content tokens for the key phrase.

9. The method of claim 1, wherein the sequence generation model is a transformer-based natural language processing model.

10. A system comprising:
one or more processors; and
memory storing instructions that, when executed by the one or more processors, cause the system to:
receive an input document;
generate, using a sequence generation model, a sequence of key phrases based on the input document, the sequence generation model omitting use of a self-generated sequence termination token during generation of the sequence; and
output, as recommended key phrases for the input document, the sequence of key phrases.

11. The system of claim 10, wherein the instructions further cause the system to:
receive a training dataset that includes a plurality of training samples, wherein each training sample includes a training document paired with one or more positive key phrase samples; and
training the sequence generation model using the training dataset.

12. The system of claim 11, wherein the instructions further cause the system to:
generate, using the sequence generation model, an additional sequence of training key phrases based on the training document of a training sample, the sequence generation model omitting use of the self-generated sequence termination token during generation of the additional sequence; and
train the sequence generation model based on a comparison of the training key phrases to the one or more positive key phrase samples of the training sample.

13. The system of claim 12, wherein the instructions further cause the system to:
select, from the plurality of training samples, first training samples that include at least a threshold number of the positive key phrase samples;
generate, using the trained sequence generation model, additional key phrases for a subset of training samples of the plurality of training samples;
select, from the subset of training samples, second training samples that include at least a threshold number of unique key phrases from the positive key phrase samples and the additional key phrases; and
re-train the sequence generation model using an augmented dataset that includes the first training samples and the second training samples.

14. The system of claim 10, wherein the instructions further cause the system to terminate the generation of the sequence of key phrases after a predefined number of key phrases have been generated by the sequence generation model.

15. The system of claim 10, wherein the instructions further cause the system to:
generate a start token that marks a start of a key phrase in the sequence of key phrases; and
generate an end token that marks an end of the key phrase, wherein the start token and the end token delineate the key phrase from other key phrases of the sequence.

16. The system of claim 15, wherein the instructions further cause the system to insert the end token of the key phrase in response to a threshold number of content tokens having been generated for the key phrase.

17. A non-transitory computer-readable storage medium storing instructions that, when executed by one or more processors, cause the one or more processors to perform operations comprising:
receiving an input document;
generating a sequence of key phrases based on the input document using a sequence generation model having been trained to generate the key phrases indefinitely;
terminating generation of the sequence in response to a threshold number of key phrases having been generated; and
outputting the sequence of key phrases.

18. The non-transitory computer-readable storage medium of claim 17, wherein generating the sequence of key phrases further comprises omitting use of a self-generated sequence termination token during generation of the sequence.

19. The non-transitory computer-readable storage medium of claim 17, wherein generating a key phrase of the sequence of key phrases further comprises:
generating a start token that marks a start of the key phrase; and
generating an end token that marks an end of the key phrase, wherein the start token and the end token delineate the key phrase from other key phrases of the sequence.

20. The non-transitory computer-readable storage medium of claim 19, wherein generating the key phrase further comprises inserting the end token of the key phrase in response to generating a threshold number of content tokens for the key phrase.
